(19) United States
(12) Patent Application Publication
(10) Pub. No.: US 2019/0014617 A1
(43) Pub. Date: Jan. 10, 2019

(54) AEROSOL-GENERATING SYSTEM WITH FOUR CONTACTS

(71) Applicant: Altria Client Services LLC, Richmond, VA (US)

(72) Inventor: Stephane BILAT, Areuse (CH)

(73) Assignee: Altria Client Services LLC, Richmond, VA (US)

(21) Appl. No.: 16/030,255

(22) Filed: Jul. 9, 2018

Related U.S. Application Data
(63) Continuation of application No. PCT/EP2018/065794, filed on Jun. 14, 2018.

(30) Foreign Application Priority Data
Jul. 7, 2017 (EP) 17180258.0

(51) Int. Cl. H05B 1/02

(52) U.S. Cl. CPC H05B 1/0297; A24F 47/008

(57) ABSTRACT

An aerosol-generating system includes an electric heater and a pair of first contacts for delivering electrical power to the electric heater. The system further includes a pair of second contacts independently contacting the electric heater for measuring the voltage between the second contacts.

### CROSS-REFERENCE TO RELATED APPLICATIONS

This is a continuation of and claims priority to PCT/EP2018/065794, filed on Jun. 14, 2018, and further claims priority to EP 17180258.0, filed on Jul. 7, 2017, both of which are hereby incorporated by reference in their entirety.

### BACKGROUND

Some example embodiments relate to an aerosol-generating system with an electric heater and contacts. Some example embodiments relate to a method for controlling the electrical power supplied to an electric heater in an aerosol-generating system and/or a cartridge for an aerosol-generating system.

In aerosol-generating systems, such as e-cigarettes, an aerosol-generating substrate such as an e-liquid is vaporized to generate an aerosol. The aerosol is subsequently inhaled by an adult vaper of the system. For vaporizing the aerosol-generating substance, an electric heater may be employed. When the aerosol-generating system is drawn upon, electrical power is transferred to the electric heater for heating the electric heater. The electric heater is configured for vaporizing the aerosol-generating substance when heated. The temperature of the heater may be controlled by controlling the voltage applied to the heater, if a constant current flows through the heater. It is also known that the electrical resistance of the electric heater depends upon the temperature of the electric heater. Thus, for controlling the temperature of the electric heater, the electrical resistance of the electric heater can be determined by a control unit based upon the measured voltage applied to the heater. For heating the electric heater to a predetermined temperature, the electrical resistance of the electric heater is determined and the flow of electrical power towards the electric heater may be controlled based upon the determined electrical resistance of the electric heater.

The electric heater may be provided in the form of a cartridge separately from a power supply, wherein the cartridge comprises the electric heater and the aerosol-generating substance. When the cartridge is connected to the power supply, which may be comprised in a main body, contacts in the main body are provided for contacting the electric heater. Elements like the contacts may form parasitical resistances. Due to these parasitical resistances, the electrical power effectively transmitted to the electric heater may vary in different cartridges or samples. This variation of resistance cannot be determined in conventional systems, which measure voltage between the contacts or determine the electrical resistance between the contacts. Particularly when the heating element of the electric heater has a very low resistance value, parasitic resistances are becoming non-negligible. Consequently, parasitic resistances may impact the transmitted electrical power to the heating element of the electric heater resulting in variations in the aerosol generation between different samples/cartridges.

### SUMMARY

In one embodiment, an aerosol-generating system includes an electric heater and a pair of first contacts for delivering electrical power to the electric heater. The system further comprises a pair of second contacts independently contacting the electric heater for measuring the voltage between the second contacts.

At least one embodiment also relates to a method for controlling the electrical power supplied to an electric heater in an aerosol-generating system, wherein the method comprises the following steps:
i) providing an aerosol-generating system, comprising an electric heater, a pair of first contacts for delivering electrical power to the electric heater, and a pair of second contacts independently contacting the electric heater for measuring the voltage between the second contacts,
ii) delivering electrical power to the electric heater through the pair first contacts,
iii) obtaining the value of current that flows between the pair of first contacts, and
iv) measuring the voltage between the pair of second contacts contacting the electric heater.
v) controlling, the electrical power supplied to the electric heater based upon the measured voltage.

At least one embodiment relates to a cartridge for an aerosol-generating system, comprising aerosol-generating substance and an electric heater, wherein the electric heater includes a heater element and two electrodes, and wherein the electrodes are configured for contacting first contacts for delivering electrical power to the electric heater, and wherein the heater element is configured for second contacts contacting the heater element for measuring the voltage between the second contacts.

### BRIEF DESCRIPTION OF THE DRAWINGS

Some example embodiments will be further described, by way of example only, with reference to the accompanying drawings in which:

FIG. 1 shows an embodiment of an electric heater with first and second contact zones;

FIG. 2 illustrates the electrical resistances with respect to the electric heater and the first and second contacts;

FIG. 3 shows a further embodiment of an electric heater with first and second contact zones;

FIG. 4 shows a further embodiment of an electric heater with first and second contact zones;

FIG. 5 shows a further embodiment of an electric heater with completely covered electrode areas;

FIG. 6 shows a perspective view of the contact portion of the aerosol-generating system with first and second contacts; and

FIG. 7 shows an aerosol-generally system according to an example embodiment.

### DETAILED DESCRIPTION

Example embodiments will become more readily understood by reference to the following detailed description of the accompanying drawings. Example embodiments may, however, be embodied in many different forms and should not be construed as being limited to the example embodiments set forth herein. Rather, these example embodiments are provided so that this disclosure will be thorough and complete. Like reference numerals refer to like elements throughout the specification.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, region, layer or section from another region, layer or section. Thus, a first element, region, layer or section discussed below could be termed a second element, region, layer or section without departing from the teachings set forth herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Example embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these example embodiments should not be construed as limited to the particular shapes of regions illustrated herein, but are to include deviations in shapes that result, for example, from manufacturing.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

In one embodiment, an aerosol-generating system includes an electric heater and a pair of first contacts for delivering electrical power to the electric heater. The system further comprises a pair of second contacts independently contacting the electric heater for measuring the voltage between the second contacts.

By providing two additional contacts, i.e., the pair of second contacts, the voltage between the second contacts can be measured. Since the second contacts are provided contacting the electric heater, essentially the voltage across the electric heater can be directly measured. In this regard, the second contacts may directly contact a heating element of the electric heater. The second contacts independently, that means separately, contact the electric heater. The first contacts and the second contacts may be configured electrically insulated from each other apart from the contacts contacting the electric heater. In this way, the initial two contacts, i.e., the pair of first contacts, are still used to transmit the electrical power to the electric heater, but the second contacts enable the measurement of the voltage across the heating element of the electric heater with a higher accuracy. The second contacts have the function of probing contacts, so that no parasitic resistances influence the measurement of the voltage across the heating element of the electric heater.

In this regard, it is to be noted that the current flowing through the electric heater is provided essentially only by the first contacts, and essentially no current flows through the electric heater by the second contacts. The second contacts are only used to measure the voltage. By knowing the current which flows through the electric heater as well as the voltage across the electric heater with high accuracy, the electric power delivered to the electric heater may be controlled in an improved or optimal manner.

The second contacts may be provided in any suitable form. The second contacts may be provided as a pair comprising a resilient clip contact and a spring contact. The second contacts may be obtained by two contact surfaces that are biased to one another. The second contacts may be provided as pogo pins or micro pogo pins for safely and directly contacting the heating element of the electric heater. Furthermore, the second contacts may have high contact resistance values so that the voltage on the heating element of the electric heater can be measured with high accuracy, while the current flowing through the second contacts and the heating element of the electric heater is negligible. The contact resistance between one of the second contacts and the heating element may be between 0 and 100 Ohms, between 0 and 20 Ohm, between 0 Ohm and 2 Ohm, and between 0.005 and 0.2 Ohm.

The electrodes of the electric heater may be covered with a tin sheet. The electrodes may also be covered with a different material, for example, a high-conductive material such as a metal sheet. The high-conductive material may also be copper, gold, silver or any combination of these materials. The high-conductive material may be provided as a coating of a single or a coating of multiple of the previous materials.

The first contacts may be provided in the form of blade contacts which are configured to improve or optimize their contact area with the electrodes. The sheet, which covers the electrodes, as well as the blade contacts, define contact zones which may potentially create parasitic resistances. In this regard, the total electrical resistance of the electric heater may comprise the electrical resistance of the blade contacts, the contact zones between the blade contacts and the tin sheets, the electrical resistance of the tin sheet, and the contact zones between the tin sheet and the heating element of the electric heater. Thus, parasitic resistances may vary between different samples/cartridges at least partly due to this configuration. The provision of second contacts directly contacting the heating element may allow to correctly determine the voltage across the heating element. The supply of electrical power to the electric heater may be adjusted such that a consistent temperature of the heating element of the electric heater may be achieved. In this regard, the temperature of the heating element of the electric heater depends upon the electrical power flowing through the heating element. This relationship may be stored in a lookup table. Thus, upon directly measuring the voltage across the heating element utilizing the second contacts, the supply of electrical power to the electric heater may be adjusted using the lookup table such that the heating element is heated to the desired temperature.

The aerosol generating system may be controlled such that a constant power is provided to the heating element. To this end, the voltage drop over the heating element is determined by utilizing the second contacts. The supply of electrical power to the electric heater may be adjusted to a specific power target.

The power target may be adjusted by the electric circuitry (described below) varying the duty cycle of the voltage source to the heater. The power target may also be adjusted by varying the voltage level on the heater in case the voltage is constant. For both cases, by acquiring the current through the first pair of contacts and with the voltage measurement on the second pair of contacts, the exact resistance of the heating element can be calculated and power can be accurately adjusted.

Additionally, the electrical resistance of the heating element can be determined with high accuracy using the measured voltage. In more detail, the resistance of the heating element can be calculated by the following first formula:

$${R}_{mesh} = \frac{{V}_{mesh}}{I} \qquad ( 1 )$$

wherein Rₘₑₛₕ denotes the electrical resistance of the heating element, Vₘₑₛₕ denotes the voltage across the heating element of the electric heater. Vₘₑₛₕ may be measured by measuring the voltage between the second contacts. I denotes the electric current flowing through the heating element of the electric heater and may be measured by conventional means or be constant. The total parasitic resistance can be calculated using the following second formula:

$${R}_{ptot} = 2 ( {R}_{blade} + {R}_{blade \text{-} tin} + {R}_{tin} + {R}_{tin \text{-} mesh} ) = ( \frac{{V}_{blade}}{I} ) - ( \frac{{V}_{mesh}}{I} ) \qquad ( 2 )$$

In the second formula, Rₚₜₒₜ denotes the total parasitic resistance, R_{blade} denotes the parasitic resistance of a blade contact, R_{blade-tin} denotes the parasitic resistance of the contact zone between the blade contact and the tin sheet, Rₜᵢₙ denotes the parasitic resistance of the tin sheet, Rₜᵢₙ₋ₘₑₛₕ denotes the parasitic resistance of the contact zone between the tin sheet and the heating element of the electric heater, and V_{blade} denotes the voltage between the first contacts, which may be provided as blades.

Using these formulas, the parasitic resistance may be determined. The electric resistance of the heater element of the electric heater may also be determined. A material may be used for the heating element, the electrical resistance of which depends upon the temperature of the heating element. Since the electrical resistance of the heating element may be determined using the measured voltage across the heating element as described above, the supply of electrical power to the electric heater may be controlled based upon the determined electrical resistance of the heating element. The correlation between the electrical resistance of the heating element and the temperature of the heating element may be stored in a lookup table. The supply of electrical power to the electric heater may be adjusted using this lookup table such that the heating element is heated to the desired temperature.

As discussed above, the contact zones of the second contacts may be located in direct contact with the heating element of the electric heater. In an alternative embodiment, the contact zone of the second contacts may also be provided in indirect contact with the heating element. The contact zones of the second contacts may be provided below or behind the contact zones of the first contacts. In such embodiment, the second contact zones are not in direct contact with the heating element, but are connected to the heating element via the first contact zones.

In this configuration the second contacts are provided outside of the main path of the heating current, and the voltage determination may thus be more accurate.

Depending on the design of the heating element, the resistance from the tin to the mesh may be almost null as well as the resistance of the tin. For such case Rₜᵢₙ₋ₘₑₛₕ and Rₜᵢₙ are negligible in the above equation. This case is identical to an embodiment in which the first pair of contacts and second pair of contacts are both contacting the tin sheet. In such cases there is no need to provide the second contact zones on an uncovered dense mesh area. Accordingly in such embodiments, the complete area of the electrodes may be covered by the tin sheet, which simplifies manufacture of the electric heater.

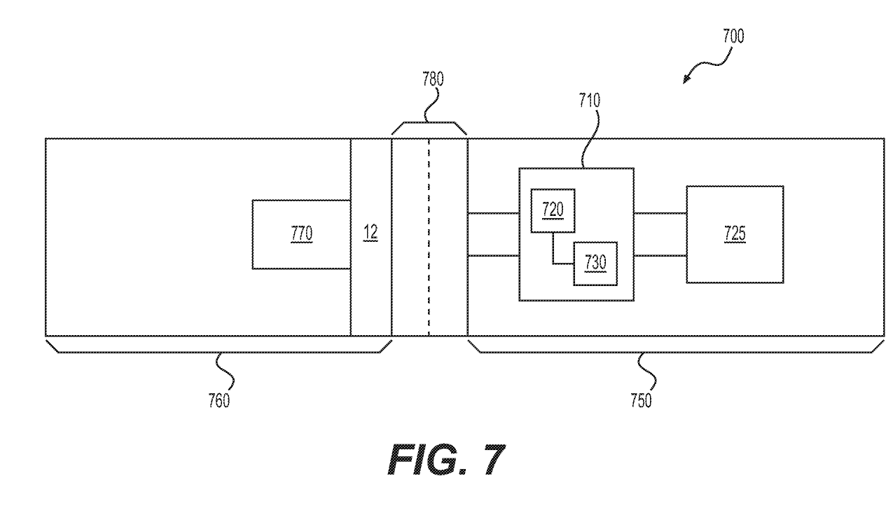

FIG. 7 illustrates an aerosol-generally system according to an example embodiment. The aerosol-generating system may also be referred to as an electronic vaping device. As shown, the aerosol-generating system 700 may comprise a control unit and a power source 720 such as a battery. The control unit may be a part or configured as electric circuitry 710. The electric circuitry 710 may comprise a microprocessor 720, which may be a programmable microprocessor. The electric circuitry 710 may comprise further electronic elements such as a memory 730 storing the look-up table and programming for the micro-processor 720. The electric circuitry 710 may be configured to regulate a supply of electrical power to the electric heater 12. Power may be supplied to the electric heater 12 continuously following activation of the system or may be supplied intermittently, such as on a puff-by-puff basis (e.g., the electronic circuitry 710 may include a puff sensor to detect a draw on the aerosol-generating system). The electrical power may be supplied to the electric heater 12 in the form of pulses of electrical current.

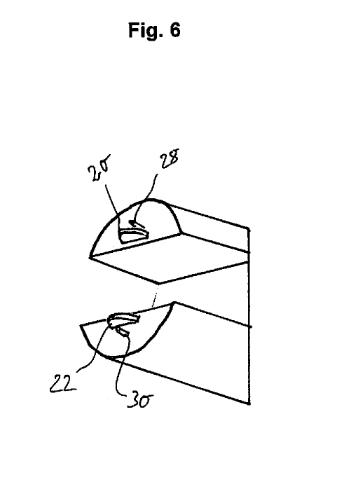

The power supply may be configured as a battery. As an alternative, the power supply may be another form of charge storage device such as a capacitor. The battery may be part of a main body or aerosol-generating device 750. The main body may comprise a housing, in which the power supply and the first and second contacts (see FIG. 6 described below) are encompassed. The power supply may require recharging and may have a capacity that allows for the storage of enough energy for one or more activations of the electric heater. For example, the power supply may have sufficient capacity to allow for a continuous generation of aerosol for a period of around 6 minutes or for a period that is a multiple of 6 minutes. In another example, the power supply may have sufficient capacity to allow for a desired (or alternatively, predetermined) number of puffs or activations of the electric heater.

Upon detection of the presence of parasitic resistances by the control unit, the control unit may increase the flow of electric energy from the power source to the electric heater so that the temperature of the electric heater reaches a desired (or alternatively, predetermined) temperature. Also, due to the knowledge of the presence of parasitic resistances, other features of the system may be improved such as the measurement of the electrical resistance to determine an empty cartridge condition. In this regard, the electrical resistance of the heating element of the electric heater may change based on the presence of aerosol-generating substance. Also, the accuracy of a safety feature to stop heating based on the electrical resistance of the heating element of the electric heater may be improved. In this regard, if the electrical resistance of the heating element of the electric heater is determined to be too low or too high, a malfunction of the electric heater may be detected and consequently, the operation of the electric heater may be stopped.

Accordingly, the control unit may be configured to prevent or authorize heating of the heating element based upon the measured voltage values. The control unit may further be configured to indicate to an adult vaper if the connection between the electronics control unit and the heating element is optimal. In case the connection is not optimal, a corresponding signal may be produced, which may invite the adult vaper to check the accessible connections of the system.

The aerosol-forming substance is a substance capable of releasing volatile compounds that can form an aerosol. The volatile compounds may be released by heating the aerosol-forming substance. The aerosol-forming substance may comprise plant-based material. The aerosol-forming substance may comprise tobacco. The aerosol-forming substance may comprise a tobacco-containing material containing volatile tobacco flavour compounds, which are released from the aerosol-forming substance upon heating. The aerosol-forming substance may alternatively comprise a non-tobacco-containing material. The aerosol-forming substance may comprise homogenised plant-based material.

The aerosol-forming substance may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Aerosol formers may be polyhydric alcohols or mixtures thereof, such as triethylene glycol, 1,3-butanediol and glycerine. The aerosol-former may be propylene glycol. The aerosol former may comprise both glycerine and propylene glycol.

The liquid aerosol-forming substance may comprise other additives and ingredients, such as flavourants. The liquid aerosol-forming substance may comprise water, solvents, ethanol, plant extracts and natural or artificial flavours. The liquid aerosol-forming substance may comprise nicotine. The liquid aerosol-forming substance may have a nicotine concentration of between about 0.5% and about 10%, for example about 2%.

As shown in FIG. 7, the aerosol-generating system 700 may be provided as a two-part system, comprising a cartridge 760 and an aerosol-generating device 750. The cartridge 760 may comprise the aerosol-generating substance 770 and the electric heater 12, while the aerosol-generating device 750 may comprise the first and second contacts. If a control unit and a power supply are provided, these elements are also comprised in the aerosol-generating device as shown.

The cartridge 760 may be any suitable shape and size. For example, the cartridge may be substantially cylindrical. The cross-section of the cartridge may, for example, be substantially circular, elliptical, square or rectangular. The cartridge 760 may comprise a housing. The housing of the cartridge may comprise a base and one or more sidewalls extending from the base. The base and the one or more sidewalls may be integrally formed. The base and one or more sidewalls may be distinct elements that are attached or secured to each other. The housing may be a rigid housing. As used herein, the term ‘rigid housing’ is used to mean a housing that is self-supporting. The rigid housing of the cartridge may provide mechanical support for the electric heater. The cartridge may comprise one or more flexible walls. The flexible walls may be configured to adapt to the volume of the liquid aerosol-forming substance held in the cartridge. The housing of the cartridge may comprise any suitable material. The cartridge may comprise substantially fluid impermeable material. The housing of the cartridge comprises a transparent or a translucent portion, such that liquid aerosol-forming substance held in the cartridge may be visible to an adult vaper through the housing. The cartridge may be configured such that aerosol-forming substance held in the cartridge is protected from ambient air. The cartridge may be configured such that aerosol-forming substance stored in the cartridge is protected from light. This may reduce the risk of degradation of the substance and may maintain a high level of hygiene.

The cartridge may be substantially sealed. The cartridge may comprise one or more semi-open inlets (now shown). This may enable ambient air to enter the cartridge. The one or more semi-open inlets may be semi-permeable membranes or one way valves, permeable to allow ambient air into the cartridge and impermeable to substantially prevent air and liquid inside the cartridge from leaving the cartridge. The one or more semi-open inlets may enable air to pass into the cartridge under specific conditions. The inlets may be sealed by an elastomeric septum to enable a refilling of the cartridge. In order to refill the cartridge, the septum may be pierced by a needle and liquid injected through the needle into the cartridge.

The cartridge may also be configured as a detachable consumable. For example, the aerosol-generating device 750 and the cartridge 760 may be connected at a connection part or interface 780 (e.g., press fit, screw fit, etc.). In this case dust, e-liquid or any insulating material may be present between the contacts of the consumable and the device when the adult vaper plugs in the consumable. Such presence of non-perfectly conductive material may increase considerably the parasitic resistance of the system leading to a very low aerosol generation as the power on the consumable would be slightly reduced. Thus, the control unit may be used to determine whether the consumable is not properly plugged or in place. Further, the system may also determine that any electronic contacts between the heater and the power source are corroded or that the heating element is damaged. In these cases a too high contact resistance between the heater element and the power source is detected.

For all these cases the control unit may react by adjusting the power or may even prevent operation of the system, if the reason for malfunction is considered to represent a safety risk. Also if proper functionality may not be guaranteed or poor performance of the system is expected, the control unit may prevent operation of the system.

The heating element of the electric heater may exemplarily be a heated coil, a heated capillary, a heated mesh or a heated metal plate. The heating element may also be a plate that is stamped or chemically etched to any specific geometries and resistances. The heating element may also comprise conductive tracks printed on an insulating substrate. The heated metal plate may be a serpentine heater or a spiral heater. The heating element is a resistive heater which receives electrical power and transforms at least a part of the received electrical power into heat energy. In one embodiment, the heating element is provided as a mesh heater with a low electrical resistance of between 0.1 Ohm to 10 Ohm preferably 0.3 Ohm to 5 Ohm, and more preferably 1 Ohm. The heating element of the electric heater may also be provided as a blade. The heating element may comprise only a single heating element or a plurality of heating elements. The temperature of the heating element is may be controlled by the control unit. The two electrodes of the electric heater may be provided as a conductive sheet on top of opposite outer regions of the heating element. These regions may be configured as dense mesh regions with a mesh density that may be higher as the mesh density of a center region of the heating element, wherein this center region of the heating element may be provided as a mesh element. A higher mesh density denotes a smaller mesh size. The dense mesh may form a more plane contact area. Also, a transition surface may be provided, for example by the provision of a gradient in the mesh density of a mesh filament constituting the heating element, such that a smooth transition of power distribution over the mesh may be achieved. The electric heater may be configured as disclosed in EP 16172196.6, which is disclosed herein.

Suitable electrically resistive materials for the electric heater include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. Examples of suitable metal alloys include stainless steel, nickel-, cobalt-, chromium-, aluminium-titanium-zirconium-, hafnium-, niobium-, molybdenum-, tantalum-, tungsten-, tin-, gallium-, manganese- and iron-containing alloys, and super-alloys based on nickel, iron, cobalt, stainless steel, Timetal® and iron-manganese-aluminium based alloys. In composite materials, the electrically resistive material may optionally be embedded in, encapsulated or coated with an insulating material or vice-versa, depending on the kinetics of energy transfer and the external physicochemical properties required. Examples of suitable composite heater elements are disclosed in U.S. Pat. No. 5,498,855, WO-A-03/095688 and U.S. Pat. No. 5,514,630, each of which is hereby incorporated by reference in their entirety.

For activating the electric heater, a puff detection system may be provided. The puff detection system may be provided as a sensor (not shown), which may be configured as an airflow sensor and may measure the airflow rate. The airflow rate is a parameter characterizing the amount of air that is drawn through the airflow path of the aerosol-generating system per time by the adult vaper. The initiation of the puff may be detected by the airflow sensor when the airflow exceeds a desired (or alternatively, predetermined) threshold. Initiation may also be detected upon an adult vaper activating a button.

The sensor may also be configured as a pressure sensor to measure the pressure of the air inside the aerosol-generating system which is drawn through the airflow path of the system by the adult vaper during a puff. The sensor may be configured to measure a pressure difference or pressure drop between the pressure of ambient air outside of the aerosol-generating system and of the air which is drawn through the system by the adult vaper. The pressure of the air may be detected at an air inlet, for example, a semi-open inlet, a mouth end of the system, an aerosol formation chamber or any other passage or chamber within the aerosol-generating system, through which the air flows. When the adult vaper draws on the aerosol-generating system, a negative pressure or vacuum is created inside the system, wherein the negative pressure may be detected by the pressure sensor. The term “negative pressure” is to be understood as a relative pressure with respect to the pressure of ambient air. In other words, when the adult vaper draws on the system, the air which is drawn through the system has a pressure which is lower than the pressure off ambient air outside of the system. The initiation of the puff may be detected by the pressure sensor if the pressure difference exceeds a desired (or alternatively, predetermined) threshold.

At least one embodiment also relates to a method for controlling the electrical power supplied to an electric heater in an aerosol-generating system, wherein the method comprises the following steps:
i) providing an aerosol-generating system, comprising an electric heater, a pair of first contacts for delivering electrical power to the electric heater, and a pair of second contacts independently contacting the electric heater for measuring the voltage between the second contacts,
ii) delivering electrical power to the electric heater through the pair first contacts,
iii) obtaining the value of current that flows between the pair of first contacts, and
iv) measuring the voltage between the pair of second contacts contacting the electric heater.
v) controlling, the electrical power supplied to the electric heater based upon the measured voltage.

At least one embodiment relates to a cartridge for an aerosol-generating system, comprising aerosol-generating substance and an electric heater, wherein the electric heater includes a heater element and two electrodes, and wherein the electrodes are configured for contacting first contacts for delivering electrical power to the electric heater, and wherein the heater element is configured for second contacts contacting the heater element for measuring the voltage between the second contacts.

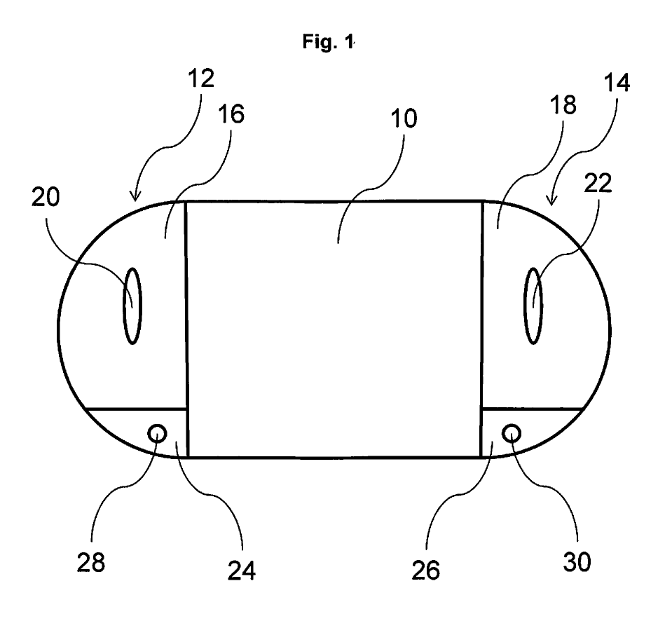

FIG. 1 shows an electric heater, which is part of an aerosol-generating system. The electric heater comprises a heating element 10 and two electrodes 12, 14.

In the electrodes 12, 14, a cover material, 16, 18, such as a tin sheet, is provided. The tin sheet 16, 18 is configured to be contacted by blade contacts 20, 22, which facilitate the transfer of electrical power from the aerosol-generating system towards the electrodes 12, 14 and the heating element 10 of the electric heater. Namely, the blade contacts 20, 22 are not part of the electronic heater, but instead contact the electronic heater as shown, for example, in FIG. 1. Adjacent to the electrodes 12, 14, uncovered regions 24, 26 are provided that are directly contacting the heating element 10. The second contacts 28, 30 are contacting the uncovered regions 24, 26 of the electrode and are used for directly measuring the voltage across the heating element 10. Namely, the second contacts 28, 30 are not part of the electronic heater, but instead contact the electronic heater as shown, for example, in FIG. 1.

The heating element 10 is provided as a mesh element, and the uncovered regions 24, 26 of the heating element 10 are also provided as mesh elements, however with a denser mesh.

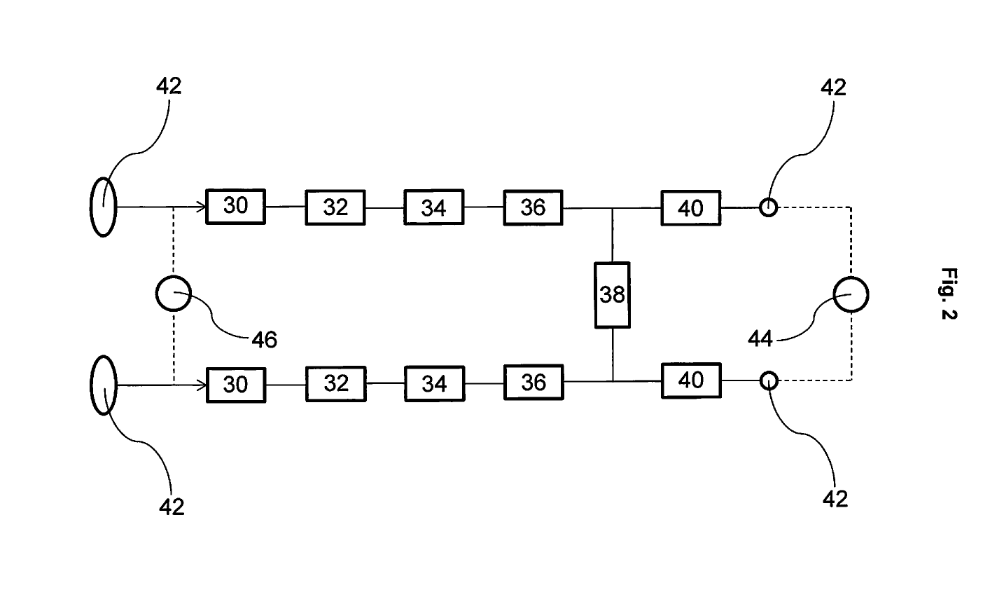

FIG. 2 shows the measurement of the voltage across the heating element 10. Furthermore, FIG. 2 shows the different resistances, and may be parasitic resistances, which occur between the blade contacts 20, 22. In more detail,
30 denotes the parasitic resistance R_{blade} of a blade contact 20, 22;
32 denotes the parasitic resistance R_{blade-tin} of the contact zone between the blade contact 20, 22 and the tin sheet 16, 18;
34 denotes the parasitic resistance Rₜᵢₙ of the tin sheet 16, 18;

36 denotes the parasitic resistance Rₜᵢₙ₋ₘₑₛₕ of the contact zone between the tin sheet 16, 18 and the heating element 10 of the electric heater;
38 denotes the electrical resistance Rₘₑₛₕ of the heating element 10;
40 denotes the electrical resistance R_{micro pogo} of the second contacts 28, 30;
42 denotes electronic circuitry for measuring the voltage Vₘₑₛₕ across the heating element 10 and for controlling the supply of electrical power to the electric heater; the electronic circuitry may also determine the electrical resistance Rₘₑₛₕ of the heating element 10 based upon the measured voltage Vₘₑₛₕ;
44 denotes the voltage Vₘₑₛₕ between the two small contact areas 28, 30; and
46 denotes the voltage V_{blade} between the two blade contacts 20, 22.

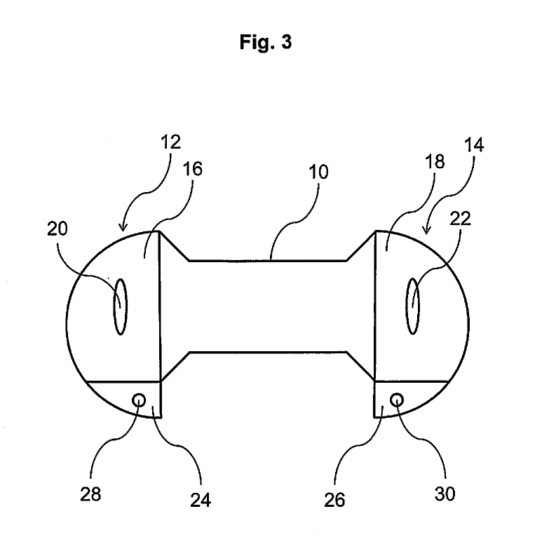

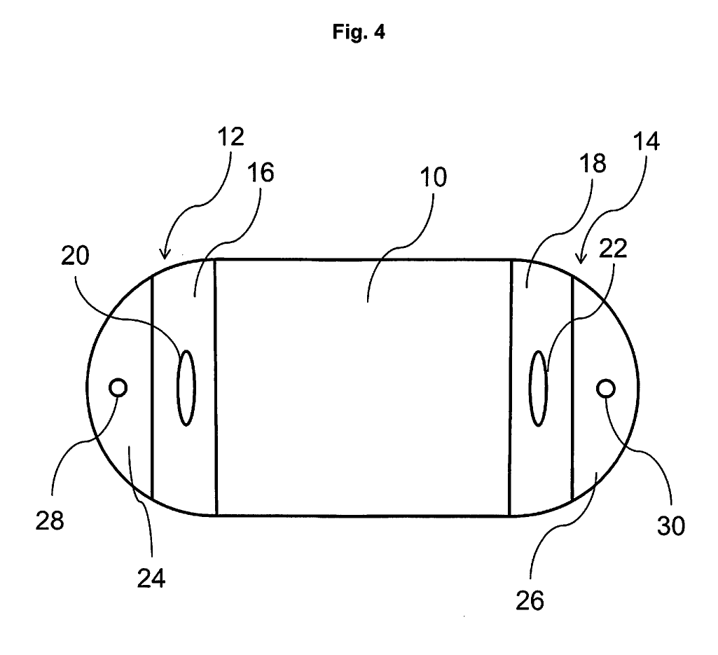

FIGS. 3 and 4 show further embodiments of the electric heater in which the uncovered regions 24, 26 of the electrodes 12, 14 are provided in indirect contact to the heating element 10.

In FIG. 3 the uncovered regions extend below the electrodes 12, 14 and are indirectly connected to the heating element 10 via the electrodes 12, 14. In FIG. 4 the uncovered regions extend behind the electrodes 12, 14 and are indirectly connected to the heating element 10 via the electrodes 12, 14.

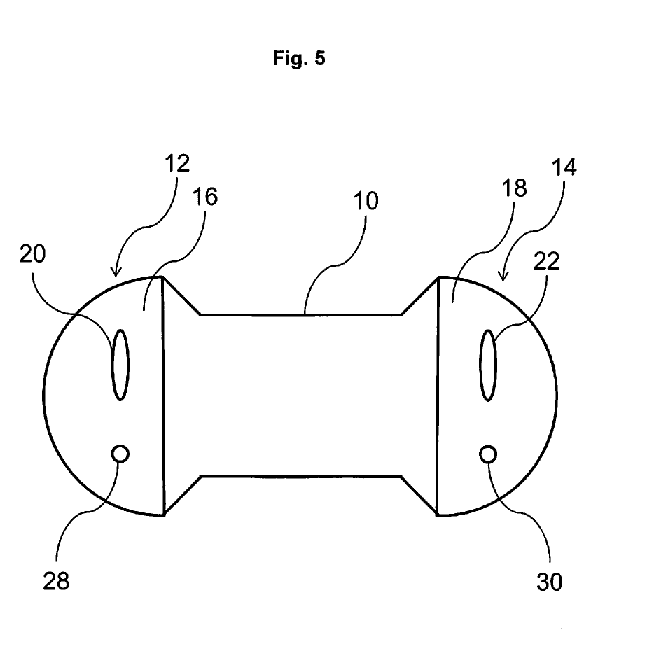

FIG. 5 shows a further alternative embodiment of the electric heater in which the complete area of the electrodes 12, 14 is covered by tin sheets 16, 18. In this embodiment, the resistance of the tin sheet itself is almost zero and the contact resistance between the tin sheet and the heater element is so low that that it does not affect the voltage measurement. In this case, all contacts may be arranged on the tin sheet and there is no need for an uncovered region. The construction of such electric heaters is simplified and the manufacture thereof may be more economical.

FIG. 6 shows the connection part of the aerosol-generating system, that is contacted with the electric heater as depicted in FIG. 4. The first contacts are provided for supplying electrical power to the electrodes 12, 14 and the heating element 10 of the electric heater. The first contacts are provided in the form of the blade contacts 20, 22 that allow for an improved or optimized contact area with the electrodes of the electric heater. Behind the blade contacts 20, 22, the second contacts 28, 30 are provided which are configured to contact the uncovered regions 24, 26 of the electric heater. The second electrical contacts are provided, in the form of spring biased pogo pins which establish a reliable contact with the electric heater. By contacting the heating element 10 through the second contacts 28, 30, the voltage drop across the heating element 10 can be precisely measured.

As described previously, additionally to the electric circuitry comprising the control unit, the aerosol-generating system further comprises a power supply, wherein the control unit is provided to control the flow of electrical power from the power supply towards the electric heater based upon the measured electrical resistance of the heating element 10 in any well-known manner.

The above described embodiments of the present application are only illustrative. The skilled person understands that the above described features can be combined with each other within the scope of the present invention.

1. Aerosol-generating system, comprising:
an electric heater;
a pair of first contacts for delivering electrical power to the electric heater; and
a pair of second contacts independently contacting the electric heater for measuring the voltage between the second contacts.

2. An aerosol-generating system according to claim 1, wherein the system further comprises electric circuitry and a power source, and wherein the electric circuitry is configured to control the electrical power supplied from the power source to the electric heater based upon the measured voltage.

3. An aerosol-generating system according to claim 2, wherein the electric circuitry is further configured to measure the voltage between the second contacts and control the electrical power supplied to the electric heater based upon the measured voltage.

4. An aerosol-generating system according to claim 2, wherein the electric circuitry is further configured to measure the voltage between the second contacts, derive the resistance of the electrical heater based upon the measured voltage, and control the electrical power supplied to the electric heater based upon the calculated resistance.

5. An aerosol-generating system according to claim 1, wherein the second contacts are configured as pogo pins.

6. An aerosol-generating system according to claim 1, wherein the electrical heater includes a heater element and two electrodes, and wherein the first contacts are configured to contact the two electrodes, and wherein the second contacts are configured for directly contacting the heater element.

7. An aerosol-generating system according to claim 6, wherein at least one of the two electrodes of the electric heater is covered by a conductive sheet.

8. An aerosol-generating system according to claim 7, wherein the first contacts are blade contacts provided on the conductive sheets.

9. An aerosol-generating system according to claim 1, wherein the heating element of the electric heater is a mesh element.

10. An aerosol-generating system according to claim 9, wherein at least one of the two electrodes is a mesh element with a denser mesh density compared to the mesh density of the mesh element in a center region of the heating element.

11. An aerosol-generating system according to one of claim 1, wherein the heating element of the electric heater is an electric coil, a heated capillary, a heated mesh, a heated metal plate or one or more heater blades.

12. An aerosol-generating system according to claim 1, wherein the system further comprises a cartridge, wherein the cartridge comprises an aerosol-generating substance, and wherein the electric heater is provided in the cartridge.

13. An aerosol-generating system according to one of claim 2, wherein the system further comprises an aerosol-generating device, wherein the aerosol-generating device comprises the first and second contacts, and wherein the aerosol-generating device comprises the electric circuitry and the power source.

14. Method for controlling the electrical power supplied to an electric heater in an aerosol-generating system, wherein the method comprises:
i) providing an aerosol-generating system, comprising an electric heater, a pair of first contacts for delivering electrical power to the electric heater, and a pair of second contacts independently contacting the electric heater for measuring the voltage between the second contacts,
ii) delivering electrical power to the electric heater through the pair of first contacts,
iii) obtaining the value of current that flows between the pair of first contacts, and
iv) measuring the voltage between the pair of second contacts contacting the electric heater.
v) controlling, the electrical power supplied to the electric heater based upon the measured voltage.

15. A cartridge for an aerosol-generating system, comprising:
aerosol-generating substance; and
an electric heater, wherein the electric heater includes a heater element and two electrodes, and wherein the electrodes are configured for contacting first contacts, and wherein the heater element is configured for independently contacting second contacts.
